(19) United States
(12) Patent Application Publication
(10) Pub. No.: US 2026/0369736 A1
(43) Pub. Date: Nov. 19, 2026

(54) FLAME-RETARDANT LIQUID

(71) Applicant: LIFESAFE TECHNOLOGIES LIMITED, Essex (GB)

(72) Inventor: Gavin CORNELIUS, Essex (GB)

(21) Appl. No.: 19/136,431

(22) PCT Filed: Dec. 8, 2023
(86) PCT No.: PCT/EP2023/084992

§ 371 Date: Jun. 6, 2025

(30) Foreign Application Priority Data
Dec. 9, 2022 (GB) 2218583.9

(51) Int. Cl. H01M 10/6567; C09K 5/10; C09K 21/06; H01M 10/613; H01M 50/24

(52) U.S. Cl. CPC H01M 10/6567; C09K 5/10; C09K 21/06; H01M 10/613; H01M 50/24

(57) ABSTRACT

The invention provides a liquid flame-retardant composition comprising one or more plant-based oils and one or more of (a) a cold flow improver; (b) an antioxidant; and (c) a mineral oil component The liquid flame-retardant composition is useful as a pretrauma fluid within a battery cell or battery pack, and/or as a general purpose coolant composition within a battery cell or battery pack.

### RELATED APPLICATIONS

This application claims the priority of UK patent application GB 2218583.9 filed on 9 Dec. 2022, the contents of which are incorporated by reference herein in their entirety.

### TECHNICAL FIELD OF THE INVENTION

The present invention relates to liquid flame-retardant compositions, the use of liquid flame-retardant compositions to prevent ignition, and methods of manufacturing liquid flame-retardant compositions.

### BACKGROUND TO THE INVENTION

A lithium-ion (Li-ion) battery contains an electrolyte between an anode and a cathode. The anode tends to be graphite and the cathode is a material having the ability to react with lithium ions. The electrolyte contains lithium salts and is flammable. Despite the name, Li-ion batteries do not contain any lithium metal (although they do contain lithium compounds in the electrodes) and so flame-retardant compositions which are tailored for metal fires are not suitable.

Li-ion batteries within EVs are particularly hazardous. EV batteries are designed to be lightweight with a high power-density, meaning that the walls of the cell are thin, and electrolyte is pressurised. The electrodes also tend to be thin, composed of materials which could rupture and deposit fragments into the electrolyte upon impact, further increasing the flammability of the electrolyte. EV batteries are of course also prone to impact caused by traffic collisions. Such impacts could easily rupture the thin walls of the structural battery components and release the pressurised flammable electrolyte. This leads to a composition which could easily ignite and is potentially explosive, presenting a hazard to the occupants of the vehicle and any passers-by. One hazardous aspect of Li-ion batteries is that as you attempt to remove the wreckage, the debris moves through the pressurised electrolyte risking reignition. The potential for reignition in this way lasts for up to 14 days after the original collision.

Furthermore, Li-ion batteries can experience thermal runaway which can lead to fire and potentially even explosion. Thermal runaway is caused by an initial increase in temperature within a cell, which causes a chemical chain reaction to take place eventually causing ignition of the flammable components. The thermal runaway can begin in a single cell which may have experienced a failure of some sort, leading to the initial temperature increase, but heating and thermal runaway in neighbouring cells may result, despite those neighbouring cells functioning correctly. As a result, a failure and thermal runaway in a single cell can cause thermal runaway in an entire battery comprising a large number of cells, leading to the loss of an entire bank of cells, many of which may have been operating correctly. This unnecessary loss of healthy cells from a battery to thermal runaway and subsequent fire is an expensive waste of useful components, let alone a very dangerous event which could lead to temperature rise and fire across all of the cells in a large battery, such as an EV battery.

Once thermal runaway has begun, the chain reaction within the cells causes a break-down in the chemicals within electrodes which releases oxygen, among other by-products. This provides an internal oxygen source which feeds the fire which eventually results from thermal runaway. Although fire extinguishing compositions have been manufactured which in theory could be applied to a battery fire, these tend to function in a similar way to “normal” fire extinguishing compositions by e.g. restricting the external oxygen supply to the fire from the surrounding atmosphere, without addressing the internal supply of oxygen resulting from the break-down of the electrodes. The unique problems associated with battery fires means that such compositions cannot always safely and effectively deal with battery fires.

Therefore, there is a need for compositions which can prevent ignition caused by thermal runaway within a cell or battery, and are effective in dealing with the unique challenges presented by a Li-ion battery fire in a manner which is safer and more efficient relative to known fire extinguishing compositions.

There is also a need for compositions which can target a specific cell and reduce the damage caused to neighbouring cells within a battery by containing the thermal runaway.

It is also desirable for compositions to be effective over a wide range of temperatures. However, particularly in cold climates, the types of composition which can be used are restricted. This is because there are safety risks associated with the liquid freezing and precipitation of dissolved components in the liquid composition. Solid particulate compositions can lead to undesirable consequences such as clogging and less effective fire prevention.

There is also a need for effective general-purpose coolant compositions which effectively cool cells or batteries during normal use and/or during a thermal runaway event. Ideally such coolant compositions should also be environmentally benign.

### SUMMARY OF THE INVENTION

Broadly speaking, the present invention provides a liquid flame-retardant composition which demonstrates a good ability to prevent fire in lithium-ion batteries, especially fire caused by thermal runaway. The liquid flame-retardant composition contains commercially available components, making its manufacture economical and straightforward. The present invention also provides the use of a liquid flame-retardant composition to prevent ignition.

Surprisingly, the liquid flame-retardant composition also provides an effective coolant composition for batteries, such as lithium-ion batteries, being able to effectively absorb and dissipate heat generated by a battery during use, reducing the risk of a thermal runaway event, while simultaneously offering the flame-retardant properties also described herein should an ignition event nonetheless occur.

The composition may therefore find use as a flame-retardant composition, coolant composition, or both.

In order to achieve this, a first aspect of the present invention is a liquid flame-retardant composition comprising one or more plant-based oils; and one or more of:
(a) a cold flow improver;
(b) an antioxidant; and
(c) a mineral oil component.

The invention also provides, in a second aspect, the use of a liquid flame-retardant composition to prevent ignition, wherein the liquid flame-retardant composition comprises one or more plant-based oils.

The inventors found that such a liquid flame-retardant composition is particularly effective in preventing or arresting thermal runaway in Li-ion battery, or arresting thermal runaway before it leads to ignition of the cell components. As explained in more detail below, the one or more plant-based oils targets the internal oxygen and fuel sources rather than merely shielding the fuel from atmospheric oxygen.

As used herein, the term “ignition” refers to the process of starting a fire. A lithium battery usually contains a lithium oxide cathode. When the battery is subjected to conditions such as high temperatures or rapid cycling, the cathode can decompose and release oxygen. If the oxygen comes in contact with other flammable products given off by the decomposition of the lithium-ion battery, or more specifically the electrolyte, under heat, spontaneous combustion (i.e. ignition) can occur. Ignition could also be caused by a spark between two components of the battery igniting a flammable component of the battery. The liquid flame-retardant composition is a “pre-trauma” composition, since it may be administered before any ignition event and bring about a reduction in temperature which makes spontaneous or spark-induced ignition much less likely to occur.

As used herein, to “prevent ignition” means to reduce the risk of ignition relative to the risk of ignition if the liquid flame-retardant composition had not been administered. In some embodiments, the use of the invention may reduce that risk to zero.

As used herein, the term “flame retardant” refers to a composition which is intended for “pre-trauma” use, to prevent or slow down ignition. This contrasts with a fire retardant composition, which is intended for “post-trauma” use after a fire has already ignited, to slow down or extinguish the fire. A flame retardant is typically located on, within or close to a flammable material and may be activated by the presence of an ignition source, causing it to act to prevent or slow down any further development of ignition with the intention that a fire does not establish.

It was surprisingly found that the one or more plant-based oils are able to contain thermal runaway within a lithium-ion cell or battery, preventing ignition of the cell. When applied to a cell or battery the one or more plant-based oils surround a cell or battery pack or components thereof. Without wishing to be bound by theory, it is believed that the application of the flame-retardant liquid to a cell undergoing thermal runaway suppresses the internal oxygen release from the decomposition of the cathode, thereby removing or reducing the internal oxygen supply and preventing ignition of the cell which would have otherwise occurred as a result of thermal runaway. The liquid is able to prevent or extinguish a fire caused by thermal runaway within a cell of a battery, thereby preventing further thermal runaway in neighbouring cells.

In addition to this, the one or more plant-based oils display very low or zero electrical conductivity and can withstand far greater voltage than a mineral oil alone could withstand. This reduces the risk of electrical arcing when the fluid is used to prevent a battery fire, thereby reducing the risk of sparking which might cause ignition of a Li-ion battery fire or lead to explosion. The liquid is therefore capable of preventing battery fires, for example Li-ion battery fires, effectively and with higher safety than existing fire extinguishing liquids.

Furthermore, the composition provides very effective coolant properties and is able to quickly dissipate any excess heat generated by operation of a battery, including excessive heat which may be generated by an event such as thermal runaway where unwanted heated of the cell or battery occurs. This further reduces the risk of damage to a cell.

Since the liquid flame-retardant composition contains plant-based oils, it is more environmentally benign. It is also straightforward to manufacture from readily available ingredients.

The invention also provides, in a third aspect, a method of manufacturing a liquid flame-retardant composition according to the first aspect comprising the steps of mixing the one or more plant-based oils with one or more of (a) the cold flow improver, (b) the antioxidant; and (c) the mineral oil component, and stirring the resulting mixture.

A fourth aspect of the present invention is a method of preventing, arresting or reversing thermal runaway in a battery cell or battery pack comprising injecting or administering the liquid flame-retardant composition according to the first aspect.

A fifth aspect of the present invention is a method of cooling a battery cell or battery pack using the liquid flame-retardant composition according to the first aspect as a coolant composition within the cell or battery.

A sixth aspect of the invention is a battery pack comprising a liquid flame-retardant composition according to the first aspect.

### First Aspect

In the following description, unless otherwise specified, percentages refer to weight percentages (wt %). By “weight percentage”, we mean the percentage by weight relative to the total weight of the liquid flame-retardant composition, unless stated otherwise.

The term “plant-based oil” as used herein refers to an oil derived from a plant source, as opposed to animal fats or petroleum. The term therefore does not encompass mineral oils, which are derived from the refining of crude oil. Non-limiting examples of plant-based oils include coconut oil, corn oil, cottonseed oil, olive oil, palm oil, peanut oil, rapeseed oil, sesame oil, sunflower oil, canola oil, soybean oil, jatropha oil, and nut oils such as almond oil.

The first aspect of the present invention is a liquid flame-retardant composition comprising one or more plant-based oils; and one or more of:
(a) a cold flow improver;
(b) an antioxidant; and
(c) a mineral oil component.

In some embodiments, the liquid flame-retardant composition comprises at least 60% plant-based oils, preferably at least 65% plant-based oils, preferably at least 70%, at least 80% or over 80% plant-based oils, based on the total weight of liquid flame-retardant composition.

In some embodiments, the liquid flame-retardant composition comprises at least 60% plant-based oils, for example at least 62%, at least 64%, at least 65%, at least 66% or at least 66.5%, based on the total weight of liquid flame-retardant composition.

In some embodiments, the liquid flame-retardant composition comprises at least 80% plant-based oils, for example at least 82%, at least 84%, at least 86%, at least 88% or at least 90%, based on the total weight of liquid flame-retardant composition.

In some embodiments, the liquid flame-retardant composition does not contain any oil-based components other than the one or more plant-based oils.

In some embodiments, the liquid flame-retardant composition consists of oil-based components. In other words, the liquid flame-retardant composition contains only the one or more plant-based oils and optionally one or more further oils (e.g. mineral oil).

In some embodiments, in addition to the one or more plant-based oils, the liquid flame-retardant composition comprises a mineral oil component.

As used herein, the term “mineral oil” refers to liquid by-product oils derived from the refining of crude oil. Mineral oils tend to contain mixtures of different higher alkanes and cycloalkanes. Other terms which are known to be used for these types of oil include white oil, paraffin oil, liquid paraffin, paraffinum liquidum and liquid petroleum. Such an oil is an excellent coolant and a poor conductor of electricity. It can be used to improve the flow properties of the flame-retardant liquid, by improving the homogeneity of the mixture. The skilled person is aware of such mineral oils and is able to choose a suitable commercially available product.

In some embodiments, the composition comprises from 0 wt % to 40 wt % mineral oil component, based on the total weight of the composition, for example from 1 wt % to 40 wt %, from 1 wt % to 35 wt %, from 5 wt % to 35 wt %, from 20 wt % to 35 wt %, from 30 wt % to 35 wt %, or about 33.3 wt % mineral oil component.

In some embodiments, the composition comprises from 0 wt % to 20 wt % mineral oil component, based on the total weight of the composition, for example from 1 wt % to 20 wt %, from 1 wt % to 15 wt %, from 5 wt % to 15 wt %, from 8 wt % to 12 wt %, or about 10 wt % mineral oil component.

In some embodiments, the composition comprises up to 20 wt % mineral oil component, based on the total weight of the composition, for example up to 19 wt %, up to 18 wt %, up to 17 wt %, up to 16 wt %, up to 15 wt %, up to 14 wt %, up to 13 wt %, up to 12 wt %, up to 11 wt % or up to 10 wt %.

In some embodiments, the liquid flame-retardant composition comprises at least 60% plant-based oils, based on the total weight of the composition, for example at least 62%, at least 64%, at least 65%, at least 66%, or at least 66.5%, with balance mineral oil component.

In some embodiments, the liquid flame-retardant composition comprises at least 80% plant-based oils, based on the total weight of the composition, for example at least 80%, at least 81%, at least 82%, at least 83%, at least 84%, at least 85%, at least 86%, at least 87%, at least 88%, at least 89% or at least 90%, with balance mineral oil component.

In some embodiments, the weight ratio of plant-based oils to mineral oils within the composition is from 1:1 to 15:1, for example from 1:1 to 10:1, from 1:1 to 8:1, from 1:1 to 5:1 or about 2:1. This balance of the amounts of plant-based oil and mineral oil provides a good balance of flame retardant properties and physical properties such as pour point, flashpoint and oxidation stability.

In some embodiments, the weight ratio of plant-based oils to mineral oils within the composition is from 1:1 to 15:1, for example from 2:1 to 10:1, from 2:1 to 8:1, from 2:1 to 5:1 or about 4:1. This balance of the amounts of plant-based oil and mineral oil provides a good balance of flame retardant properties and physical properties such as pour point, flashpoint and oxidation stability.

In some embodiments, the composition comprises or consists of a plant-based oil component comprising one or more plant-based oils and a mineral oil component comprising one or more mineral oils. In some embodiments, the composition consists of a plant-based oil component comprising one or more plant-based oils and a mineral oil component comprising one or more mineral oils. In some embodiments, the composition comprises from 60 wt % to 70 wt % plant-based oil component and from 30 wt % to 40 wt % mineral oil component, wherein the total amount of plant-based oil component and mineral oil component is 100 wt %. In some embodiments, the composition comprises from 65 wt % to 67 wt % plant-based oil component and from 33 wt % to 35 wt % mineral oil component, wherein the total amount of plant-based oil component and mineral oil component is 100 wt %.

In some embodiments, the composition comprises from 70 wt % to 95 wt % plant-based oil component and from 5 wt % to 30 wt % mineral oil component, wherein the total amount of plant-based oil component and mineral oil component is 100 wt %. In some embodiments, the composition comprises from 75 wt % to 85 wt % plant-based oil component and from 15 wt % to 25 wt % mineral oil component, wherein the total amount of plant-based oil component and mineral oil component is 100 wt %. In some embodiments, the composition comprises about 80 wt % plant-based oil component and about 20 wt % mineral oil component, wherein the total amount of plant-based oil component and mineral oil component is 100 wt %.

In some embodiments, the mineral oil component comprises hydrotreated heavy naphthenic distillates, based on the total weight of the liquid flame-retardant composition.

Hydrotreated heavy naphthenic distillates (CAS number: 64742-52-5) is a complex combination of hydrocarbons obtained by treating a petroleum fraction with hydrogen in the presence of a catalyst. It has a low pour point and good solvency properties. It also has excellent stability owing to it being extensively hydrated.

When hydrotreated heavy naphthenic distillates are present in the flame-retardant liquid, properties such as the pour point, flashpoint and stability against oxidation can be improved compared to a flame-retardant liquid comprising no hydrotreated naphthenic distillates.

In some embodiments, the mineral oil component comprises a mixture of mineral oil (also known as white oil or liquid paraffin) and hydrotreated heavy naphthenic distillates (CAS number: 64742-52-5). In some embodiments, the mineral oil component consists of a mixture of mineral oil (also known as white oil or liquid paraffin) and hydrotreated heavy naphthenic distillates. In some embodiments, the mineral oil component comprises a mixture of mineral oil (also known as white oil or liquid paraffin) and hydrotreated heavy naphthenic distillates, in a weight ratio of from 2:1 to 1:2, for example from 1.5:1 to 1:1.5, for example about 1:1.

In some embodiments, the composition comprises at least two different plant-based oils in admixture. In some embodiments, the composition comprises at least three different plant-based oils in admixture.

Particularly good liquid flame-retardant compositions have a high flash point and no or low conductivity. Such properties can be achieved when the composition comprises two or more plant-based oils as the different properties of the plant-based oils can be exploited to create a composition with the most favourable properties.

In some embodiments, the composition has a flashpoint above 160 °C, for example above 170 °C, above 180 °C, above 190 °C, above 200 °C, above 210 °C, above 220 °C, above 230 °C, above 240 °C or above 170 °C. In some embodiments, the composition has a flashpoint of from 160 °C to 300 °C, for example from 180 °C to 300 °C, from 200 °C to 300 °C, from 200 °C to 280 °C or from 200 °C to 250 °C.

The flashpoint is the lowest temperature at which a substance vaporises into a gas, which can be ignited with the introduction of an external source of fire.

The ignition temperature is the lowest temperature at which a volatile material will be vaporised into a gas which ignites without the help or any external flame or ignition source.

A Li-ion battery would ignite around 150 °C and would explode around 535 °C. Therefore, the liquid flame-retardant composition preferably has a flashpoint above the ignition temperature of a lithium-ion battery. This is because it is preferable that the flame-retardant liquid is able to cool down a cell or battery pack without vaporising into a flammable gas up to the ignition temperature of a cell or battery pack. Therefore, the higher the flash point of the liquid flame-retardant composition, the better its ability to cool down a cell or battery pack that has reached higher temperatures, and the better its safety.

In some embodiments, the composition has an electrolytic conductivity of less than 2000 pS m⁻¹, for example less than 1500 pS m⁻¹, less than 1000 pS m⁻¹, less than 500 pS m⁻¹, less than 400 pS m⁻¹, less than 300 pS m⁻¹, less than 200 pS m⁻¹, less than 100 pS m⁻¹, less than 50 pS m⁻¹, less than 20 pS m⁻¹, less than 10 pS m⁻¹, less than 5 pS m⁻¹ or less than 2 pS m⁻¹.

In some embodiments, the composition has an electrolytic conductivity of from 0.1 pS m⁻¹ to 2000 pS m⁻¹, for example from 0.1 pS m⁻¹ to 100 pS m⁻¹, from 0.1 pS m⁻¹ to 10 pS m⁻¹, from 0.1 pS m⁻¹ to 5 pS m⁻¹, or from 0.1 pS m⁻¹ to 2 pS m⁻¹. Electrolytic conductivity can be measured by the method in ASTM D4308-21.

In some embodiments, at least one of the one or more plant-based oils comprises from 20 wt % to 85 wt % oleic acid, for example from 20 wt % to 80 wt % oleic acid, from 20 wt % to 70 wt % oleic acid or from 20 wt % to 45 wt % oleic acid, based on the total weight of that plant-based oil.

In some embodiments, at least one of the one or more plant-based oils comprises from 60 wt % to 70 wt % oleic acid, based on the total weight of that plant-based oil. In some embodiments, plant-based oil component consists of one or more plant-based oils, wherein each plant-based oil within the plant-based oil component comprises from 60 wt % to 70 wt % oleic acid, based on the total weight of that plant-based oil. In some embodiments, plant-based oil component consists of two different plant-based oils, wherein each plant-based oil within the plant-based oil component comprises from 60 wt % to 70 wt % oleic acid, based on the total weight of that plant-based oil.

In some embodiments, at least one of the one or more plant-based oils comprises from 25 wt % to 90 wt % unsaturated fatty acids (including both monounsaturated and polyunsaturated fatty acids), based on the total weight of that plant-based oil, for example from 30 wt % to 90 wt %, from 60 wt % to 90 wt %, from 80 wt % to 90 wt % or from 83 wt % to 88 wt %.

In some embodiments, at least one of the one or more plant-based oils comprises from 5 wt % to 15 wt % saturated fatty acids, based on the total weight of that plant-based oil, for example from 5 wt % to 14 wt %, from 6 wt % to 14 wt %, from 8 wt % to 12 wt % or from 9 wt % to 11 wt %.

In some embodiments, at least one of the one or more plant-based oils has an iodine value of at least 70, for example at least 75 or from 75 to 100. In some embodiments, at least one of the one or more plant-based oils has an iodine value of from 75 to 95.

In some embodiments, at least one of the one or more plant-based oils has an iodine value of at least 100, for example at least 105 or at least 110. In some embodiments, at least one of the one or more plant-based oils has an iodine value of from 110 to 150, for example from 110 to 145. Iodine value is an indication of the degree of unsaturation of an oil and can be determined by the method in ISO 3961:2018.

In some embodiments, at least one of the one or more plant-based oils has a saponification value of at least 180, for example at least 185. In some embodiments, at least one of the one or more plant-based oils has a saponification value of from 185 to 200, for example from 185 to 195 or from 189 to 195. Saponification value is the number of milligrams of alkali required to saponify one gram of the plant-based oil, using the method set out in ASTM D5558-95 (2017).

In some embodiments, at least one of the one or more plant-based oils comprises from 20 wt % to 85 wt % oleic acid, from 25 wt % to 90 wt % unsaturated fatty acids (including both monounsaturated and polyunsaturated fatty acids) and from 5 wt % to 15 wt % saturated fatty acids, based on the total weight of that plant-based oil. In some embodiments, at least one of the one or more plant-based oils comprises from 20 wt % to 85 wt % oleic acid, from 25 wt % to 90 wt % unsaturated fatty acids (including both monounsaturated and polyunsaturated fatty acids) and from 5 wt % to 15 wt % saturated fatty acids, based on the total weight of that plant-based oil, and has an iodine value of from 110 to 150 and a saponification value of from 185 to 200.

In some embodiments, at least one of the one or more plant-based oils has a density of from 910 to 920 kg/m³, for example from 912 to 920 kg/m³, from 913 to 920 kg/m³, from 915 to 920 kg/m³, from 915 to 919 kg/m³, from 918 to 919 kg/m³, from 918.5 to 919.0 kg/m³, or from 918.7 to 918.9 kg/m³.

In some embodiments, the liquid flame-retardant composition comprises one or more plant-based oils selected from olive oil, canola oil, rapeseed oil, sunflower oil, and jatropha oil. In some embodiments, the liquid flame-retardant composition comprises two different plant-based oils selected from olive oil, canola oil, rapeseed oil, sunflower oil, and jatropha oil. In some embodiments, the liquid flame-retardant composition comprises a single type of plant-based oil selected from canola oil, rapeseed oil, sunflower oil, and jatropha oil. In some embodiments, the liquid flame-retardant composition comprises a single type of plant-based oil which is sunflower oil.

Such plant-based oils are commercially available, for example as food products, and the skilled person is able to choose a suitable oil.

Sunflower oil has a particularly high flashpoint and has been observed to effectively and quickly reduce the temperature of a bank of cells which has experienced a thermal runaway event, preventing fire.

In some embodiments, the plant-based oil component consists of a mixture of two different plant-based oils. In some embodiments, the plant-based oil component consists of a mixture of two different plant-based oils, wherein one of the oils is olive oil. In some embodiments, the plant-based oil component consists of a mixture of two different plant-based oils, wherein one of the oils is virgin olive oil. In some embodiments, the plant-based oil component consists of a mixture of two different plant-based oils, wherein one of the oils is rapeseed oil. In some embodiments, the plant-based oil component consists of a mixture of olive oil, for example virgin olive oil, and rapeseed oil.

In some embodiments, the liquid flame-retardant composition comprises one or more plant-based oils and a mineral oil component, wherein the one or more plant-based oils are selected from canola oil, rapeseed oil, sunflower oil, and jatropha oil. In some embodiments, the liquid flame-retardant composition comprises or consists of sunflower oil and a mineral oil component. In some embodiments, the liquid flame-retardant composition comprises or consists of one or more plant-based oils and a mineral oil component, wherein the mineral oil component comprises or consists of a mixture of mineral oil and hydrotreated heavy naphthenic distillates (CAS number: 64742-52-5); and wherein the one or more plant-based oils are selected from canola oil, rapeseed oil, sunflower oil, and jatropha oil. In some embodiments, the liquid flame-retardant composition comprises or consists of sunflower oil and a mineral oil component, wherein the mineral oil component comprises or consists of a mixture of mineral oil and hydrotreated heavy naphthenic distillates (CAS number: 64742-52-5).

A good flame-retardant will select a plant-based oil or a combination of plant-based oils, optionally with a mineral oil component, that will provide the most desirable properties for preventing a fire. Said properties include a high flashpoint and no conductivity.

In some embodiments, the liquid flame-retardant composition comprises at least 30 wt % olive oil based on the total weight of the liquid flame-retardant composition, for example from 30 wt % to 50 wt %, from 30 wt % to 40 wt % or from 30 wt % to 35 wt %.

In some embodiments, the liquid flame-retardant composition comprises at least 30 wt % canola oil based on the total weight of the liquid flame-retardant composition, for example from 30 wt % to 50 wt % or from 33 wt % to 45 wt %.

In some embodiments, the liquid flame-retardant composition comprises from 0 wt % to 50 wt % rapeseed oil based on the total weight of the liquid flame-retardant composition, for example from 10 wt % to 50 wt %, from 15 wt % to 35 wt % or from 30 wt % to 35 wt %.

In some embodiments, the liquid flame-retardant composition comprises 30 wt % to 35 wt % olive oil, and 30 wt % to 35 wt % rapeseed oil, based on the total weight of the liquid flame-retardant composition. In some embodiments, the plant-based oil component of the liquid flame-retardant composition comprises 45 wt % to 55 wt % olive oil, for example from 50 wt % to 55 wt %, and 45 wt % to 55 wt % rapeseed oil, for example from 45 to 50 wt %, based on the total weight of the plant-based oil component. In some embodiments, the plant-based oil component of the liquid flame-retardant composition comprises about 52 wt % olive oil, and about 48 wt % rapeseed oil, based on the total weight of the plant-based oil component.

In some embodiments, the liquid flame-retardant composition comprises or consists of:
30 wt % to 35 wt % olive oil,
30 wt % to 35 wt % rapeseed oil, and
30 wt % to 35 wt % mineral oil component,
   based on the total weight of the liquid flame-retardant composition.

In some embodiments, the liquid flame-retardant composition comprises or consists of:
30 wt % to 35 wt % olive oil,
30 wt % to 35 wt % rapeseed oil,
15 wt % to 20 wt % hydrotreated heavy naphthenic distillates (CAS number: 64742-52-5), and
15 wt % to 20 wt % white mineral oil (liquid paraffin),
   based on the total weight of the liquid flame-retardant composition.

In some embodiments, the liquid flame-retardant composition comprises from 0 wt % to 90 wt % sunflower oil, for example from 15 wt % to 90 wt % or from 15 wt % to 80 wt %.

In some embodiments, the liquid flame-retardant composition comprises 0 wt % to 30 wt % jatropha oil, for example from 0 wt % to 28 wt % or from 20 wt % to 28 wt %.

In some embodiments, the composition comprises olive oil and rapeseed oil in admixture. In some embodiments, the plant-based oil component comprises or consists of olive oil and rapeseed oil in admixture. A mixture of olive oil and rapeseed oil has been found to provide an excellent balance of electrical insulation, heat dissipation and stability, along with good viscosity and flash point.

In some embodiments, in addition to the one or more plant-based oils and (when present) the mineral oil component, the liquid flame-retardant composition comprises an additive component. In some embodiments the additive component comprises one or more additives each independently selected from antioxidants and cold-flow improvers.

In some embodiments, the liquid flame-retardant composition comprises an antioxidant. An antioxidant helps delay lipid oxidation in oils, which would otherwise produce oxidative fragments (some of which are volatile). This oxidation can have adverse effects on the performance of the liquid flame-retardant composition. Therefore, an antioxidant increases the shelf life of the liquid flame-retardant composition.

In some embodiments, the liquid flame-retardant composition comprises an antioxidant, wherein the antioxidant is:
(a) a natural antioxidant comprising one or more of phenol, a tocopherol, a carotenoid, an ascorbic acid and/or its derivatives, a lignan compound, a flavonoid, a polyphenol and/or a phenolic acid, or
(b) a synthetic antioxidant optionally comprising one or more of butylated hydroxyanisole (BHA), and/or butylated hydroxytoluene (BHT), or
(c) a combination thereof.

In some embodiments, the liquid flame-retardant composition comprises phenol as an antioxidant.

In some embodiments, the liquid flame-retardant composition comprises from 0 wt % to 10 wt % antioxidant, based on the total weight of the liquid flame-retardant composition, for example from 0.1 wt % to 10 wt %, from 0.1 wt % to 5 wt %, from 0.1 wt % to 2 wt %, from 0.1 wt % to 1 wt %, from 0.5 wt % to 1 wt % or from 0.8 wt % to 1 wt %.

In some embodiments, the liquid flame-retardant composition comprises a cold flow improver. A cold flow improver is an additive to improve flow of a liquid in cold weather. A cold flow improver may improve use by modifying the size and structure of the molecules in a liquid that precipitate out at low temperatures. Alternatively, a cold flow improver may improve use by depressing the pour point, which delays agglomeration.

The pour point of a liquid is the temperature below which the liquid loses its flow characteristics. Being able to operate at lower temperatures is especially useful, for example, in cold climates.

In some embodiments, the cold-flow improver of the liquid flame-retardant composition comprises a wax dispersant, an anti-settling agent, and/or a wax modifier.

A dispersant is a substance that can improve the separation of particles and prevent their settling or clumping in a liquid. An anti-settling agent prevents precipitates to settle out of a liquid and collecting on surfaces. Wax modifiers act on was crystals to change their shape and prevent them from stacking and getting bigger.

In some embodiments, the cold flow improver is polymeric, optionally comprising one or more ethylene-vinyl acetate (EVA) copolymers, comb polymers, polyoxyalkylene compounds, and/or di-block hydrocarbon polymers.

In some embodiments, the cold flow improver is ‘Hydra Winter Cold Flow Fuel Additive’, a cold flow improver manufactured by ‘HYDRA®’.

In some embodiments, the flame-retardant fluid comprises from 0 wt % to 10 wt % cold flow improver, based on the total weight of the liquid flame-retardant composition, for example from 0.05 wt % to 10 wt %, from 0.05 wt % to 5 wt %, from 0.05 wt % to 2 wt %, from 0.05 wt % to 1 wt %, from 0.05 wt % to 0.5 wt % or from 0.05 wt % to 0.15 wt %.

In some embodiments, the flame-retardant liquid comprises aloe vera extract. In some embodiments the aloe vera extract comprises a composition extracted from the leaf of the aloe vera plant and may comprise additional components, for example additional water. Without wishing to be bound by theory it is believed that aloe vera extract improves the flow properties of the flame-retardant liquid by reducing its viscosity. Aloe vera extract, for example aloe vera juice or aloe vera water can be obtained commercially, for example from catering wholesalers.

In some embodiments, the liquid flame-retardant composition comprises from 60 to 90 wt % a plant-based oil component and from 10 to 40 wt % a mineral oil component (based on the total weight of liquid flame-retardant composition); wherein the plant-based oil component comprises from 50 to 100 wt % olive oil (based on the total weight of plant-based oil component), and the mineral oil component comprises 40 to 60 wt % white oil (liquid paraffin) and 60 to 40 wt % hydrotreated heavy naphthenic distillates (based on the total weight of mineral oil component).

In some embodiments, the liquid flame-retardant composition comprises from 60 to 90 wt % a plant-based oil component and from 10 to 40 wt % a mineral oil component (based on the total weight of liquid flame-retardant composition); wherein the plant-based oil component comprises from 50 to 100 wt % sunflower oil (based on the total weight of plant-based oil component), and the mineral oil component comprises 40 to 60 wt % white oil (liquid paraffin) and 60 to 40 wt % hydrotreated heavy naphthenic distillates (based on the total weight of mineral oil component).

In some embodiments, the liquid flame-retardant composition consists of from 60 to 90 wt % a plant-based oil component and from 10 to 40 wt % a mineral oil component (based on the total weight of liquid flame-retardant composition); wherein the plant-based oil component comprises from 50 to 100 wt % sunflower oil (based on the total weight of plant-based oil component), and the mineral oil component comprises 40 to 60 wt % white oil (liquid paraffin) and 60 to 40 wt % hydrotreated heavy naphthenic distillates (based on the total weight of mineral oil component).

In some embodiments, the liquid flame-retardant composition consists of from 60 to 90 wt % a plant-based oil component and from 10 to 40 wt % a mineral oil component (based on the total weight of liquid flame-retardant composition); wherein the plant-based oil component comprises from 50 to 100 wt % olive oil (based on the total weight of plant-based oil component), and the mineral oil component comprises 40 to 60 wt % white oil (liquid paraffin) and 60 to 40 wt % hydrotreated heavy naphthenic distillates (based on the total weight of mineral oil component).

In some embodiments, the liquid flame-retardant composition consists of from 60 to 90 wt % a plant-based oil component and from 10 to 40 wt % a mineral oil component (based on the total weight of liquid flame-retardant composition); wherein the plant-based oil component consists of from 50 to 100 wt % sunflower oil (based on the total weight of plant-based oil component), and the mineral oil component consists of 40 to 60 wt % white oil (liquid paraffin) and 60 to 40 wt % hydrotreated heavy naphthenic distillates (based on the total weight of mineral oil component).

In some embodiments, the liquid flame-retardant composition consists of from 60 to 90 wt % a plant-based oil component and from 10 to 40 wt % a mineral oil component (based on the total weight of liquid flame-retardant composition); wherein the plant-based oil component consists of from 50 to 100 wt % olive oil (based on the total weight of plant-based oil component), and the mineral oil component consists of 40 to 60 wt % white oil (liquid paraffin) and 60 to 40 wt % hydrotreated heavy naphthenic distillates (based on the total weight of mineral oil component).

In some embodiments, the liquid flame-retardant composition consists of from 60 to 90 wt % a plant-based oil component and from 10 to 40 wt % a mineral oil component (based on the total weight of liquid flame-retardant composition); wherein the plant-based oil component consists of from 40 to 60 wt % olive oil and from 60 to 40 wt % rapeseed oil (based on the total weight of plant-based oil component), and the mineral oil component consists of 40 to 60 wt % white oil (liquid paraffin) and 60 to 40 wt % hydrotreated heavy naphthenic distillates (based on the total weight of mineral oil component).

This particular mixture of components demonstrates a good balance of properties including a high flash point (around 225 °C), reduced aging in the presence of copper wire, a high autoignition point of around 330-360 °C and good thermal conductivity. Furthermore, it was surprisingly found that this compositional mixture resulted in a decrease in thermal conductivity as temperature increases. This means that the ability of the composition to insulate a traumatised cell and prevent thermal runaway increases as temperature increases. This is surprising because compositions of this type would usually be expected to demonstrate the reverse trend, i.e. an increase in thermal conductivity as temperature increases. In addition to these advantages, the composition is more environmentally benign than known coolants or pre-trauma fluids, due to the majority plant-based oil component.

In some embodiments, the liquid flame-retardant composition consists of from 60 to 90 wt %, for example from 70 to 90 wt % a plant-based oil component and from 10 to 40 wt %, for example from 10 to 30 wt % a mineral oil component (based on the total weight of liquid flame-retardant composition); wherein the plant-based oil component consists of sunflower oil, and the mineral oil component consists of 40 to 60 wt % white oil (liquid paraffin) and 60 to 40 wt % hydrotreated heavy naphthenic distillates (based on the total weight of mineral oil component).

In some embodiments, the liquid flame-retardant composition has a viscosity of from 30 to 50 mPa·s at 38 °C, as determined using a rotary viscometer, for example from 35 to 45 mPa·s, or about 40 mPa·s. Viscosity may be determined using a rotary viscometer using, for example, the method according to ASTM D445-23.

In some embodiments, the liquid flame-retardant composition has a thermal conductivity of from 0.1 to 5 W/(mK), for example from 0.1 to 2 W/(mK), from 0.1 to 1 W/(mK), from 0.1 to 0.5 W/(mK), or about 0.22 W/(mK).

In some embodiments, the liquid flame-retardant composition has a heat capacity of from 1.5 to 2.5 (kJ)/(kgK), for example from 1.8 to 2.4 (kJ)/(kgK), from 1.9 to 2.3 (kJ)/(kgK), or from 1.97 to 2.25 (kJ)/(kgK).

### Second Aspect

A second aspect of the invention is the use of a liquid flame-retardant composition to prevent ignition, wherein the liquid flame-retardant composition comprises one or more plant-based oils.

In some embodiments, the use of the liquid flame-retardant composition of the second aspect is aimed at preventing ignition in a battery cell or a battery pack. Thus in some embodiments the second aspect of the invention is the use of a liquid flame-retardant composition to prevent ignition in a battery cell or a battery pack, wherein the liquid flame-retardant composition comprises one or more plant-based oils. In some embodiments the second aspect of the invention is the use of a liquid flame-retardant composition to slow, prevent or reverse thermal runaway in a battery cell or a battery pack, wherein the liquid flame-retardant composition comprises one or more plant-based oils. In some embodiments the second aspect of the invention is the use of a liquid flame-retardant composition to contain thermal runaway or ignition to a portion of the cells within a battery pack, wherein the liquid flame-retardant composition comprises one or more plant-based oils.

In some embodiments of the second aspect, the use comprises injecting or dispensing the liquid flame-retardant composition such that the liquid flame-retardant composition comes into contact with a cell. In some embodiments of the second aspect, the use comprises injecting or dispensing the liquid flame-retardant composition such that the liquid flame-retardant composition comes into contact with the cathode within a cell.

The liquid may be administered very quickly and is able to effectively reduce the temperature of the cell before thermal runaway can proceed far enough to cause serious damage to the battery pack.

The use of the second aspect allows a much smaller quantity of liquid flame-retardant composition to be used relative to more traditional fire extinguishing techniques which aim to cover the entire area of a fire with the composition post-ignition. Since the use of the invention is able to target a specific cell within a battery, for example by injecting a small amount of the liquid when needed pre-ignition, to arrest thermal runaway, the amount of liquid used is kept to a minimum. Only a small amount is needed sufficient to at least partially surround the cathode and reduce its temperature to avoid fire. This provides materially efficient fire prevention, avoids mess and avoids damaging other parts of the battery pack by avoiding contact of other parts with the liquid.

Furthermore, since the application of the liquid is targeted, it only becomes necessary to replace a small number of cells in the battery pack, for example a single bank of cells rather than every cell. Battery packs often contain thousands of cells, especially large battery packs such as used in an EV battery. These are often contained in banks of 24 cells. The use of the invention may administer the liquid to a single bank of cells, thereby necessitating the subsequent removal and replacement of only that single bank of cells from the battery pack rather than requiring the complete replacement of the entire battery pack.

### Third Aspect

A third aspect of the invention is a method of manufacturing a liquid flame-retardant composition according to the first aspect comprising the steps of mixing the one or more plant-based oils with one or more of (a) the cold flow improver, (b) the antioxidant; and (c) the mineral oil component, and stirring the resulting mixture.

In some embodiments, the mixing is performed at a temperature of from 25 °C to 120 °C, for example from 25 °C to 100 °C, 25 °C to 50 °C, from 25 °C to 45 °C, from 30 °C to 45 °C, from 35 °C to 45 °C, or at a temperature of about 40 °C.

Mixing may be performed in any suitable vessel or container and may be achieved by any suitable mixing equipment known to the skilled person, either manually or using a mixing device.

Mixing may be performed until a homogeneous mixture is achieved. In some embodiments the liquid is stirred or mixed for at least 10 mins, for example at least 30 mins, at least 45 mins, at least 1 hour, or at least 2 hours. Such mixing times ensure that a suitable homogeneous liquid is achieved and ensures that any additives are properly dispersed within the mixture.

The order of addition of the components in the mixture is not of great importance.

Vegetable oils primarily consist of triglycerides, but several other compounds are also present. Some of these additional compounds, such as diglycerides, tocopherols, sterols, and sterol esters, need not necessarily be removed during processing. Other compounds and impurities such as phosphatides, free fatty acids, odiferous volatiles, colorants, waxes, and metal compounds may negatively affect taste, smell, appearance and storage stability of the refined oil. In addition some of these additional compounds, particularly the phosphatides, are valuable raw materials so it may be beneficial to purify vegetable oils to maximize the removal of impurities in a way that least impacts the compounds removed so that they may be recovered and reused.

In some embodiments, one or more of the one or more plant-based oils is bleached prior to the mixing step. In other words, in some embodiments the method comprises bleaching one or more of the one or more plant-based oils followed by mixing the one or more plant-based oils with one or more of (a) the cold flow improver, (b) the antioxidant; and (c) the mineral oil component, and stirring the resulting mixture.

Bleaching plant-based oils is a refining process which removes contaminants and impacts the performance of the plant-based oils. The bleaching process may remove oxidation products, phosphatides, pigments, metals and soaps.

Bleaching can occur via multiple mechanisms such as:
(a) adsorption, which is a process by which a solid holds molecules of a gas or liquid or solute as a thin film. This can occur through surface attractions involving van der Waal's forces, through chemisorption, and using molecular sieves. This involves mixing the oil with an adsorbent such as activated clay, silica gel, activated charcoal or waste ash then heating it for a period of time at temperatures above 40 °C;
(b) absorption, which is a process by which atoms, molecules, or ions enter a bulk phase (liquid, gas, or solid). Absorption differs from adsorption, since the atoms/molecules/ions are taken up by the volume, not the surface;
(c) filtration, which is a process of trapping or physically removing suspended contaminants;
(d) catalysis, which is a process by which contaminants are degraded by interactions with the surface of the catalyst;
(e) heat treatment, which is a process by which the oil is heated to a high temperature and the temperature is maintained for some time.

Bleaching can improve the stability of oils, increasing their shelf-life. It can also reduce the viscosity of oils, which is favourable for a flame-retardant liquid as it facilitates the penetration of smaller pores.

In some embodiments, the bleaching step comprises filtration through clay.

In some embodiments, the bleaching step comprises filtration through bleaching materials including one or more of neutral earth (commonly termed natural clay or fuller's earth), acid activated earth, activated carbons, and silicates.

In some embodiments, the clay used comprises palygorskite (a magnesium aluminium phyllosilicate found in clay soil), and/or bentonite (an absorbent swelling clay consisting mostly of montmorillonite).

In some embodiments the bleaching step comprises heating to a temperature of from 25 °C to 80 °C, for example from 25 °C to 60 °C, from 30 °C to 50 °C, from 35 °C to 45 °C, or to a temperature of about 40 °C, followed by filtration through clay.

In some embodiment, the bleaching step comprises heating the composition to a temperature of 60 °C for 12 hours, followed by heating to a temperature of 40 °C for 12 hours.

In some embodiments, the bleaching step is carried out in a container equipped with one or more heat exchangers. In some embodiments the container has a capacity of 2000 to 10,000 L, for example about 5000 L.

In some embodiments the one or more plant-based oils is deodorised. In other words, in some embodiments the method comprises deodorising one or more of the one or more plant-based oils followed by mixing the one or more plant-based oils with one or more of (a) the cold flow improver, (b) the antioxidant; and (c) the mineral oil component, and stirring the resulting mixture. When the bleaching step is also performed it may occur either before or after the deodorising step.

Deodorisation removes free fatty acids, volatile compounds such as oxidative compounds and other contaminants based on their vapour pressure and volatility.

In some embodiments, the deodorising step comprises vacuum steaming.

### Fourth Aspect

A fourth aspect of the present invention is a method of preventing, arresting or reversing thermal runaway in a battery cell or battery pack comprising injecting or administering the liquid flame-retardant composition according to the first aspect.

In some embodiments of the fourth aspect, thermal runaway can be prevented by targeting specific cell or battery pack. Through this selective approach, damages are contained to the source. This improves the safety of batteries and reduces the potential damages of a fire, reducing the number of cells that need replacement.

A fifth aspect of the present invention is a method of cooling a battery cell or battery pack using the liquid flame-retardant composition according to the first aspect as a coolant composition within the cell or battery.

A sixth aspect of the invention is a battery pack comprising a liquid flame-retardant composition according to the first aspect.

### BRIEF DESCRIPTION OF THE DRAWINGS

FIG. 1 is a schematic representation of apparatus for testing the conductivity of a liquid using a multifunctional tester.

### EXAMPLES

Method A or Method B was used to prepare the liquid compositions set out in Examples 1 to 5. All percentage weight compositions in the following examples are based on the total weight of the liquid flame retardant composition.

### Method A

1. Clay-bleached plant-based oils, deodorised using a vacuum steaming process, were added to a mixing vessel;
2. The mixture was heated to 40 °C;
3. Further components of the composition were added where present;
4. The mixture was stirred at 40 °C for 2 hours.

### Method B

1. The plant-based oil component(s) was filtered by passing through a clay filter (Fuller's earth clay);
2. All components were added to a mixing vessel;
3. The mixture was heated to 40 °C;
4. The mixture was stirred at 40 °C for 2 hours.

Example 1: a flame-retardant composition was manufactured according to method A, consisting of the following ingredients (where the total amount of ingredients totaled 100 wt %):
33 wt % to 45 wt % canola oil
15 wt % to 35 wt % rapeseed oil
15 wt % to 35 wt % Aloe Vera water
0.5 wt % to 1 wt % Phenol
0.05 wt % to 0.15 wt % Hydra winter cold flow improver

Example 2: a flame-retardant composition was manufactured according to method A, consisting of the following ingredients (where the total amount of ingredients totaled 100 wt %):
33 wt % to 45 wt % canola oil
15 wt % to 35 wt % sunflower oil
20 wt % to 28 wt % jatropha oil
10 wt % to 15 wt % Aloe Vera water
0.5 wt % to 1 wt % phenol
0.05 wt % to 0.15 wt % Hydra winter cold flow improver

Example 3: a flame-retardant composition was manufactured according to method A, consisting of the following ingredients (where the total amount of ingredients totaled 100 wt %):
33 wt % to 45 wt % canola oil
15 wt % to 35 wt % rapeseed oil
40 wt % to 50 wt % Aloe Vera water
0.5 wt % to 1 wt % phenol
0.05 wt % to 0.15 wt % Hydra winter cold flow improver

Example 4: a flame-retardant composition was manufactured according to method B, consisting of the following ingredients (where the total amount of ingredients totaled 100 wt %):
70 wt % to 90 wt % sunflower oil
10 wt % to 30 wt % mineral oil component containing white mineral oil (liquid paraffin) and hydrotreated naphthenic distillates (CAS number: 64742-52-5)

Example 5: a flame-retardant composition was manufactured according to method B, consisting of the following ingredients (where the total amount of ingredients totaled 100 wt %):
30 wt % to 35 wt % olive oil
30 wt % to 35 wt % rapeseed oil
15 wt % to 20 wt % hydrotreated heavy naphthenic distillates (CAS number: 64742-52-5), and
15 wt % to 20 wt % white mineral oil (liquid paraffin)

Some of the physical properties and observations of Example 5 were recorded as follows:

| Property | Value | |
|---|---|---|
| Freezing point | Solidifies at −40 °C, begins to | |
| | thicken as temperature is | |
| | reduced towards this | |
| Smoke point | 190 | °C |
| Flash point | 225 | °C |
| Autoignition point | 330-360 | °C |
| Thermal | 0.22 | W/(mK) |
| conductivity | | |
| Viscosity @ 38 °C | 40 | mPa · s |
| Viscosity @ 0 °C | 168 | mPa · s |
| Viscosity @ 20 °C | 84 | mPa · s |
| Viscosity @ 60 °C | 21 | mPa · s |
| pH | 5.3-5.6 | |
| Heat capacity | 1.97-2.25 | (kJ)/(kgK) |

The plant-based oils were obtained from a catering wholesale supplier. The other ingredients are all commercially available.

### Conductivity Tests

A number of liquids were tested to determine conductivity by measuring the resistance between two conductors immersed in the liquid.

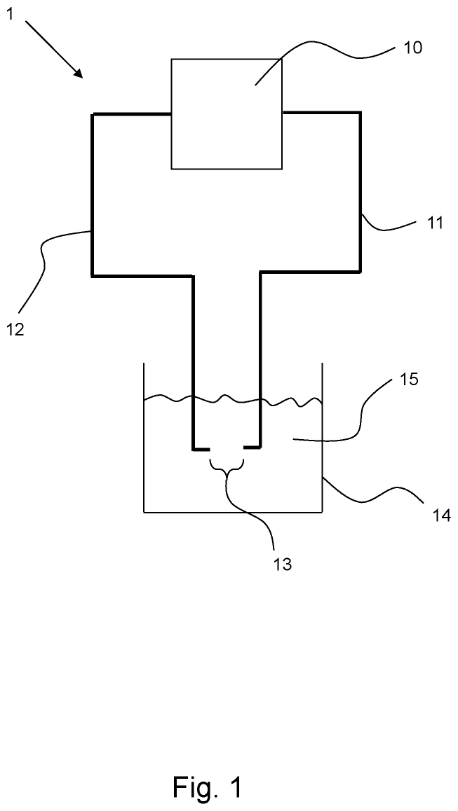

A Metrel MI 3125 BT multifunctional tester was used to measure the resistance of the liquids. A schematic diagram of the testing apparatus is shown in FIG. 1. Testing was performed according to the EN 61557-2 standard for testing insulation resistance.

Multifunctional tester 1 is connected to live and neutral conductors 11 and 12 respectively. The distance 13 between the end of the live conductor 11 and the end of the neutral conductor 12 is fixed by holding the conductors in a fixed position relative to one another. The distance 13 between the conductors is 2 mm. Insulated copper wires were used for conductors 11 and 12.

The ends of the conductors 11 and 12 were placed into a beaker 14 and immersed in test liquid 15 such that the test liquid 15 fully covered both exposed ends of conductors 11 and 12 and the gap between them.

A reading was then taken from the multifunctional tester for the resistance of the liquid. A high resistance indicates low conductivity, which is desirable for a liquid which is intended for use within batteries where electrical arcing is a risk.

The results are provided in Table 1.

TABLE 1

| | Test voltage | Measured resistance |
|---|---|---|
| Test liquid | (V) | (MΩ) |
| Tap water | 3 | 0 |
| (comparative) | | |
| Example 1 | 1050 | >999 |
| Example 4 | 1050 | >999 |
| Example 5 | 1050 | >999 |

The results show that the liquids of Examples 1, 4 and 5 each have very low conductivity and would be suitable for use as a flame-retardant liquid for batteries in order to reduce the risk of electrical arcing. Separate tests were then performed on the Example 1 liquid at voltages of 5000 V and 30 kV, with the results still showing zero conductivity of the liquid.

### Flash Point Tests

The flash point for each of the liquids of Examples 1-5 were determined.

To determine the flash point, a metal container with a diameter of 360 mm was filled with three litres of test composition. The composition was heated homogeneously using a tar burner. The temperature at ignition of the composition was recorded using an IR thermometer. This measurement was repeated three times, and the average reading calculated from the three repeats was taken to be the flash point.

The results are provided in Table 2 below.

TABLE 2

| Test liquid | Flash point (°C) |
|---|---|
| Example 1 | 250 |
| Example 2 | 160 |
| Example 3 | 160 |
| Example 4 | 216 |
| Example 5 | 225 |

The results reveal flash points around or higher than the typical ignition temperature of an electrochemical cell (approx. 160 °C), indicating that the liquids could safely be used as pre-trauma flame retardant compositions within a battery pack.

In a further test, the flash point of Example 5 was tested again but under sealed conditions. The Example 5 composition performed well in this test at temperatures exceeding 500 °C.

### Composition Aging Tests

The degree of aging of the compositions brought about by exposure to copper wire was assessed.

Example 5 in particular showed significantly reduced aging when exposed to copper wire. Example 5 therefore demonstrated high physical stability in combination with a high flash point.

### Pre-Trauma Fire Retardancy Tests

### Test 1—Liquid of Example 1

A bank of electrochemical cells was modified so that a single cell could be heated to induce thermal runaway. A 6 L fire extinguisher vessel was filled with test liquid and equipped with an outlet tube for delivery of the liquid directly to the heated cell. The outlet tube was positioned such that the liquid would be administered directly to the cathode of the cell.

The battery pack also contained a thermometer located within the cell which was heated for continuous monitoring of the cell temperature.

The cell was heated by supplying an electric current until thermal runaway was induced. The temperature reading from the thermometer gradually increased. When the temperature reached 160 °C, 200 mL of Example 1 liquid from the 6 L extinguisher vessel was discharged into the cell. The temperature reading from the thermometer immediately began to fall, and continued to fall, reaching 50 °C only 20 seconds after the injection of the liquid.

### Test 2—Liquid of Example 4

A bank of electrochemical cells was modified so that a single cell could be heated to induce thermal runaway. A 6 L fire extinguisher vessel was filled with test liquid and equipped with an outlet tube for delivery of the liquid directly to the heated cell. The outlet tube was positioned such that the liquid would be administered directly to the cathode of the cell.

The battery pack also contained a thermometer located within the cell which was heated for continuous monitoring of the cell temperature.

The cell was heated by supplying an electric current until thermal runaway was induced. The temperature reading from the thermometer gradually increased. When the temperature reached 160 °C, 200 mL of Example 4 liquid from the 6 L extinguisher vessel was discharged into the cell. The temperature reading from the thermometer immediately began to fall, and continued to fall. The temperature of the cell fell to 50% of the temperature reached in the cell before Example 4 liquid was injected within 20 seconds after the injection of the liquid. The initial temperature of the cell before the test was started was recovered within minutes of injecting Example 4 liquid.

### Test 3—Liquid of Example 5

The procedure in Test 4 was repeated for the composition of Example 5. The composition performed similarly well in preventing thermal runaway of the cells, with the temperature reducing very quickly from the 160 °C initial “trauma” temperature to an optimum operating temperature of around 77 °C within seconds.

The result of these tests show that, when the liquid of the invention is administered directly to an electrochemical cell which is undergoing a thermal runaway event, the thermal runaway is reversed and a safe temperature is reached within the very short time, removing the risk of ignition of the cell and thereby preventing fire and/or explosion.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A liquid flame-retardant composition comprising one or more plant-based oils; and one or more of:
(a) a cold flow improver;
(b) an antioxidant; and
(c) a mineral oil component.

2. The composition according to claim 1, wherein the liquid flame-retardant composition comprises at least 60 wt % plant-based oils, optionally at least 80 wt % plant-based oils, based on the total weight of liquid flame-retardant composition.

3. The composition according to claim 1 or 2, wherein the liquid flame-retardant composition comprises up to 40 wt % mineral oil component, optionally up to 20 wt % mineral oil component, based on the total weight of the composition.

4. The composition according to claim 3, wherein the weight ratio of plant-based oils to mineral oil component within the composition is from 1:1 to 15:1.

5. The composition according to claim 3 or 4, wherein the mineral oil component comprises a mixture of mineral oil and hydrotreated heavy naphthenic distillates (CAS number: 64742-52-5).

6. The composition according to any one of claims 1 to 5, wherein the liquid flame-retardant composition has a flashpoint above 160 °C, preferably above 200 °C, preferably above 250 °C.

7. The composition according to any one of claims 1 to 6, wherein at least one of the plant-based oils comprises from 20 wt % to 45 wt % oleic acid, based on the total weight of that plant-based oil.

8. The composition according to any one of claims 1 to 6, wherein at least one of the plant-based oils comprises from 60 wt % to 70 wt % oleic acid, based on the total weight of that plant-based oil.

9. The composition according to any one of claims 1 to 8, wherein at least one of the plant-based oils comprises from 25 wt % to 90 wt % unsaturated fatty acids (including both monounsaturated and polyunsaturated fatty acids), based on the total weight of that plant-based oil.

10. The composition according to any one of claims 1 to 9, wherein the liquid flame-retardant composition comprises one or more plant-based oils selected from olive oil, canola oil, rapeseed oil, sunflower oil, and jatropha oil.

11. The composition according to any one of claims 1 to 10, wherein the liquid flame-retardant composition comprises from 30 wt % to 35 wt % olive oil.

12. The composition according to any one of claims 1 to 11, wherein the liquid flame-retardant composition comprises from 30 wt % to 35 wt % rapeseed oil.

13. The composition according to any one of claims 1 to 12, wherein the liquid flame-retardant composition comprises or consists of:
30 wt % to 35 wt % olive oil,
30 wt % to 35 wt % rapeseed oil,
15 wt % to 20 wt % hydrotreated heavy naphthenic distillates (CAS number: 64742-52-5), and
15 wt % to 20 wt % white mineral oil (liquid paraffin),
based on the total weight of the liquid flame-retardant composition.

14. The composition according to any one of claims 1 to 12, wherein the liquid flame-retardant composition comprises from 15 wt % to 90 wt % sunflower oil.

15. The composition according to any one of claims 1 to 14, wherein the liquid flame-retardant composition comprises a single type of plant-based oil which is sunflower oil.

16. The composition according to any one of claims 1 to 15, wherein the composition comprises an antioxidant selected from phenol, a tocopherol, a carotenoid, an ascorbic acid and/or its derivatives, a lignan compound, a flavonoid, a polyphenol and/or a phenolic acid, butylated hydroxyanisole (BHA), butylated hydroxytoluene (BHT), or a combination thereof.

17. The composition according to any one of claims 1 to 16, wherein the liquid flame-retardant composition comprises from 0.1 wt % to 10 wt % antioxidant based on the total weight of the liquid flame-retardant composition.

18. The composition according to any one of claims 1 to 17, wherein the cold flow improver is a wax dispersant, an anti-settling agent, and/or a wax modifier.

19. The composition according to any one of claims 1 to 18, wherein the liquid flame-retardant composition comprises from 0.05 wt % to 10 wt % cold flow improver based on the total weight of the liquid flame-retardant composition.

20. The use of a liquid flame-retardant composition to prevent ignition, wherein the liquid flame-retardant composition comprises one or more plant-based oils.

21. The use of claim 20 to prevent ignition in a battery cell or battery pack.

22. The use of claim 20 or 21; wherein the liquid flame-retardant composition is a composition according to any one of claims 1 to 19.

23. The use of the liquid flame-retardant composition according to any one of claims 1 to 19 as a coolant within a battery cell or battery pack.

24. A method of preventing, arresting or reversing thermal runaway in a battery cell or battery pack comprising injecting or administering a liquid flame-retardant composition comprising one or more plant-based oils; wherein the composition is optionally according to any one of claims 1 to 19.

25. A method of manufacturing a liquid flame-retardant composition according to any one of claims 1 to 19 comprising the steps of mixing the one or more plant-based oils with one or more of (a) the cold flow improver, (b) the antioxidant, and (c) the mineral oil component, and stirring the resulting mixture.

26. A method according to claim 25, wherein the mixing is performed at a temperature of from 25 °C to 120 °C.

27. A method according to claim 25 or 26, wherein the liquid is stirred for at least 1 hour.

28. A method according to any one of claims 25 to 27, wherein the method comprises bleaching and/or deodorising one or more of the one or more plant-based oils before mixing any components together.

29. A battery pack comprising a liquid flame-retardant composition according to any of claims 1 to 19.
